(19) United States
(12) Patent Application Publication
(10) Pub. No.: US 2006/0259211 A1
(43) Pub. Date: Nov. 16, 2006

(54) Track-guided transport system

(75) Inventors: Werner Fischer, Morfelden-Walldorf (DE); Dirk Kansy, Schopp (DE); Michael Zorn, Selters im Taunus (DE)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Duerr Systems GmbH, Stuttgart (DE)

(21) Appl. No.: 11/404,437

(22) Filed: Apr. 14, 2006

Related U.S. Application Data
(63) Continuation of application No. PCT/EP04/11513, filed on Oct. 14, 2004.

(30) Foreign Application Priority Data
Oct. 16, 2003 (DE) 103 48 259.8

(51) Int. Cl. G06F 17/00

(52) U.S. Cl. 701/19; 701/1

(57) ABSTRACT

To provide a track-guided transport system, in particular a suspended monorail system, comprising a data transmission line arranged along a track and at least one vehicle, which can be run along the track and comprises at least one mobile data handling unit to receive signals from the data transmission line and/or to transmit signals to the data transmission line, in which it is possible to have relevant data passed to the vehicle at its current position in a simple manner or to have the vehicle at its current position transmit relevant data to its surrounding area, it is proposed that the transport system comprises at least one local stationary data handling unit, which comprises a signal transmitter, which transmits a signal, which is received by the mobile data handling unit of the vehicle, and/or a signal receiver, which receives a signal, which is transmitted from the mobile data handling unit of the vehicle.

### RELATED APPLICATION

This application is a continuation application of PCT/EP2004/011513 filed Oct. 14, 2004, and claims priority to German patent application number 103 48 259.8, filed Oct. 16, 2003, all of which are hereby incorporated by reference.

### FIELD OF THE DISCLOSURE

The present invention relates to a track-guided transport system, in particular a suspended monorail system, comprising a data transmission line arranged along a track and at least one vehicle, which can be run along the track and comprises at least one mobile data handling unit to receive signals from the data transmission line and/or to transmit signals to the data transmission line.

### BACKGROUND

Such a track-guided transport system is known from the patent document DE 195 12 107 A1.

In the track-guided transport system of DE 195 12 107 A1, a near-field probe arranged on the vehicle communicates with a data transmission line configured as a leaky waveguide conductor in order to transmit information concerning position, loading state and other relevant data from the vehicle to a central stationary station or to communicate with other vehicles.

Since the data communication in this case occurs exclusively via the data transmission line running along the entire travel route, it is not possible to pass local information in a targeted manner to the vehicle as a function of its respective position.

The object forming the basis of the present invention is to provide a track-guided transport system of the aforementioned type, in which it is possible to have relevant data passed to the vehicle at its current position in a simple manner or to have the vehicle at its current position transmit relevant data to its surrounding area.

### SUMMARY OF THE INVENTION

This object is achieved according to the invention in that the transport system comprises at least one local stationary data handling unit, which comprises a signal transmitter, which transmits a signal, which is received by the mobile data handling unit of the vehicle, and/or a signal receiver, which receives a signal, which is transmitted from the mobile data handling unit of the vehicle.

Therefore the concept forming the basis of the invention according to the invention is to use the mobile data handling unit of the vehicle not only for communication with the global data transmission line, but at the same time also for communication with the local data handling unit.

In this case, the local stationary data handling unit is different from the central stationary station, which receives data from the vehicle via the data transmission line or transmits data via the data transmission line to the vehicle.

The data communication between the local stationary data handling unit, on the one hand, and the mobile data handling unit of the vehicle, on the other hand, preferably occurs directly without any interposed data transmission line.

The local stationary data handling unit can transmit a plurality of relevant data for the operation of the vehicle at its current position to the mobile data handling unit of the vehicle.

Thus, for example, it can be provided that the stationary data handling unit is connected to a temperature sensor and transmits the local temperature determined by the temperature sensor to the mobile data handling unit of the vehicle.

In addition, it can be provided that the local stationary data handling unit is connected to a handling device, for example, a loading or unloading device, of the transport system and transmits relevant data for a loading or unloading operation of the vehicle from the vehicle to the respective device or from the respective device to the vehicle.

In addition, it can also be provided that the local stationary data handling unit is connected to a processing device and transmits relevant data for the processing of a working part arranged on the vehicle from the vehicle to the processing device or from the processing device to the vehicle.

Information concerning the respectively current position of the vehicle within the track system of the track-guided transport system in particular is needed for control of the vehicle.

In known track-guided transport systems, the position determination is achieved by means of transponders, which are arranged along the track of the track-guided transport system and are scanned or read by means of a reading head arranged on the vehicle. However, a disadvantage in this case is that a separate reading head system is necessary for the position determination of the vehicle.

However, if it is advantageously provided that at least one of the stationary data handling units is configured as a position indicator, which comprises a position signal transmitter, which transmits a position signal, which is received by the mobile data handling unit of the vehicle, then this allows a sufficiently exact determination of the position of the vehicle in the track system in a simple manner without an auxiliary system being necessary to scan and read transponders arranged along the track, since the mobile data handling unit of the vehicle, which is provided in any case for communication with the data transmission line, is at the same time also used to receive the position signal transmitted from the position signal transmitter.

This results in a low equipment expenditure in the vehicle and an increased reliability of the position determination system.

To enable as exact a localization of the vehicle within the transport system as possible, the transport system preferably comprises a plurality of position indicators spaced from one another along the track.

To increase the accuracy of the position determination, it can be provided that the position indicator comprises an auxiliary marking and that the vehicle comprises an auxiliary sensor, by means of which the auxiliary marking is detectable.

The current position of the vehicle in relation to the auxiliary marking can be determined accurately to the millimeter by means of such an auxiliary sensor.

The auxiliary marking can comprise, for example, an optical marking and the auxiliary sensor can comprise an optical sensor.

Alternatively or additionally hereto, it can be provided that the auxiliary marking comprises an electrically conductive element and the auxiliary sensor comprises an inductive sensor to detect the electrically conductive element.

In a preferred configuration of the transport system according to the invention, it is provided that the transport system comprises a plurality of stationary data handling units, which are spaced from one another along the track.

In principle, the stationary data handling unit and the mobile data handling unit of the vehicle can comprise any desired transmitting and receiving systems, which can communicate with one another for the transfer of data.

However, in a preferred configuration of the invention, it is provided that the signal transmitter of the stationary data handling unit is configured as a bluetooth transmitter and/or as a UMTS transmitter and/or as a “wireless LAN” (WLAN) transmitter.

In addition, it can be provided that the stationary data handling unit also comprises a signal receiver, which can communicate with the mobile data handling unit.

In particular, this signal receiver can be configured, for example, as a bluetooth receiver and/or as a UMTS receiver and/or as a “wireless LAN” (WLAN) receiver.

It is particularly favorable if the stationary data handling unit comprises a combined signal transmitter/receiver.

In particular, this combined signal transmitter/receiver can be configured, for example, as a bluetooth transmitter/receiver and/or as a UMTS transmitter/receiver and/or as a “wireless LAN” (WLAN) transmitter/receiver.

Moreover, in a preferred configuration of the invention, it is provided that the mobile data handling unit comprises a near-field coupler. It is particularly favorable if the mobile data handling unit comprises a bluetooth receiver and/or a UMTS receiver and/or a “wireless LAN” (WLAN) receiver.

Moreover, it can be provided that the mobile data handling unit also comprises a signal transmitter, which can communicate with the stationary data handling unit.

In particular, this signal transmitter can be configured, for example, as a bluetooth transmitter and/or as a UMTS transmitter and/or as a “wireless LAN” (WLAN) transmitter.

It is particularly favorable if the mobile data handling unit comprises a combined signal transmitter/receiver.

In particular, this combined signal transmitter/receiver can be configured, for example, as a bluetooth transmitter/receiver and/or UMTS transmitter/receiver and/or as a “wireless LAN” (WLAN) transmitter/receiver.

No further details have as yet been given regarding the configuration of the data transmission line.

In a preferred configuration of the invention, it is provided that the data transmission line comprises a leaky waveguide conductor.

In particular, this leaky waveguide conductor can be configured as an open coaxial conductor.

The use of a slotted coaxial conductor as leaky waveguide conductor is particularly preferred.

In principle, the data transmission line can be arranged in any desired way along the running track of the vehicle.

In a preferred configuration of the invention it is provided that the transport system comprises at least one rail section, on which the vehicle is movably guided, and that the data transmission line is held on the rail section.

In particular, it can be provided that the data transmission line is arranged between an energy transmission line and a running surface of the rail section. In this way, the rail section forms a particularly compact unit with the data transmission line arranged thereon and the energy transmission line.

In addition, it can be provided that the signal transmitter and/or the signal receiver of the stationary data handling unit is also held on the rail section.

In particular, it can be provided that the signal transmitter and/or the signal receiver of the stationary data handling unit is arranged between an energy transmission line and a running surface of the rail section.

The position signal transmitter can be connected to a stationary power supply network, for example, for its energy supply.

Further features and advantages of the invention are the subject of the following description of a practical example.

### BRIEF DESCRIPTION OF THE DRAWINGS

FIG. 1 is a schematic cross-section through a rail of a suspended monorail system with schematic representation of the bearing rollers and guide rollers as well as an energy transmission unit and a mobile data handling unit of a vehicle of the suspended monorail system;

FIG. 2 is a schematic side view of the rail from FIG. 1 with the vehicle omitted; and

FIG. 3 is a schematic side view of the rail from FIG. 1 with the vehicle of the suspended monorail system present.

Identical or functionally equivalent elements have been given the same references in all the figures.

### DETAILED DESCRIPTION OF THE INVENTION

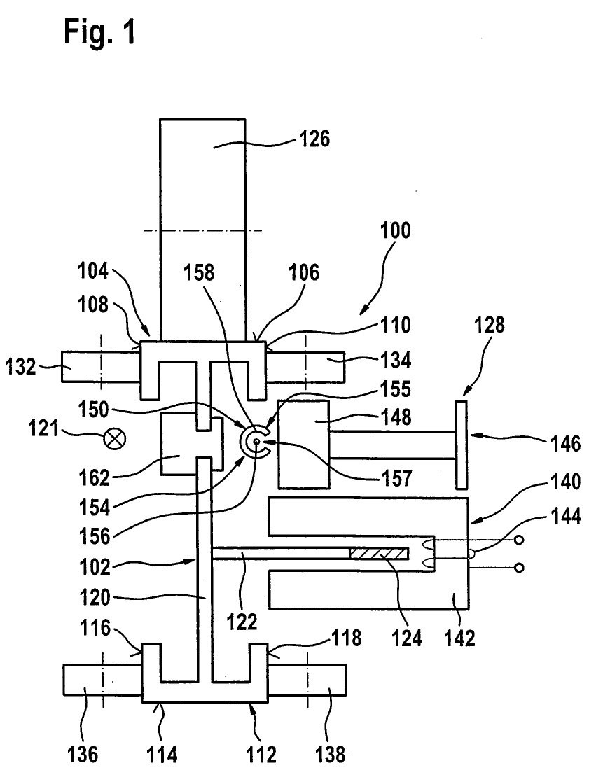

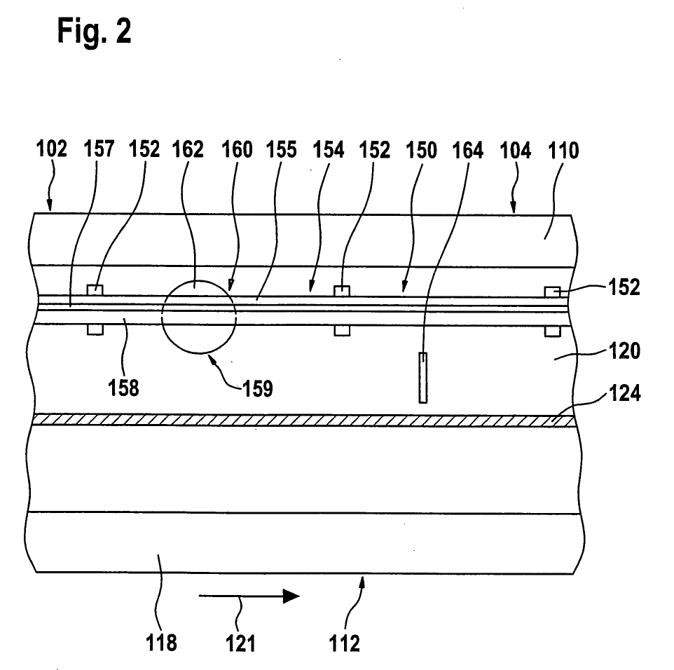

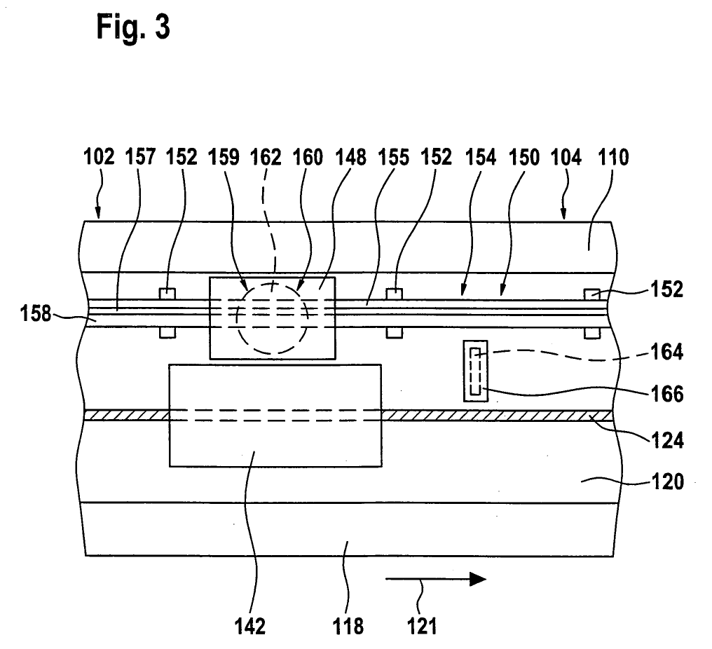

A suspended monorail system given the overall reference 100 comprises a rail 102, shown in cross-section in FIG. 1 and in side view in FIGS. 2 and 3, which has an upper flange 104 with an upper substantially plane running surface 106 and two lateral guide surfaces 108 and 110 as well as a lower flange 112 with a lower plane running surface 114 and two lateral guide surfaces 116 and 118.

The two flanges are connected to one another at their side opposite the running surfaces via a vertical web 120, the walls of which are plane and run parallel to the longitudinal direction 121 of the rail.

A power supply line carrier 122 formed from an electrically insulating material projects from a side wall of the web 120 between the two chords 104 and 112 and carries a power supply line 124 at its end remote from the web 120.

An bearing roller 126 of a vehicle 128 of the suspended monorail system 100 runs on the upper running surface 106 of the rail 102.

Of this vehicle 128, besides the bearing roller 126, the figures show only lateral guide rollers 132, 134, 136 and 138, which run on the lateral guide surfaces 108, 110, 116 or 118, as well as an energy transmission unit 140 and a mobile data handling unit 146.

The energy transmission unit 140 comprises, for example, a current collector 142, which is configured in the form of a U-shaped ferrite core and on which is arranged a conductor winding 144, which is connected to an electronic circuit (not shown) of the current collector to convert an alternating current induced in the conductor winding into a direct voltage.

The power supply line 124 penetrates into the U-shaped current collector 142 of the energy transmission unit 140 without touching this.

The energy transmission of the power supply line 124 to the energy transmission unit 140 is achieved through induction. For this, a medium-frequency alternating current is fed into the power supply line 124 and the rail 102 serving as a return conductor and generates an accordingly time-variable magnetic flux in the current collector 142, so that an alternating current can be induced in the conductor winding 144 and can be converted into a direct voltage in the vehicle 128 for drive and control purposes.

The vehicle 128 is supported on the rail 102 by means of several bearing rollers 126 and is guided on the lateral guide surfaces of the rail 102 by means of the guide rollers 132, 134, 136 and 138.

In addition, the vehicle 128 can be driven with a driving unit (not shown), which can be configured as a friction drive.

The mobile data handling unit 146 of the vehicle 128 comprises a near-field coupler 148, which is held on the vehicle 128 above the energy transmission unit 140 and is configured for bidirectional communication with a data transmission line 150, which extends along the rail 102 and is held via mountings 152 (see FIG. 2) on the side wall of the web 120 of the rail 102 facing the near-field coupler 148.

The data transmission line 150 is configured as a coaxial conductor 155 with a central copper conductor 156 and a casing 158 surrounding this, wherein on the side facing the near-field coupler 148 of the vehicle 128 the casing 158 has an axial slot 157, which extends in the longitudinal direction of the coaxial conductor 155 and through which high-frequency waves can exit from the coaxial conductor 155 or enter the coaxial conductor 155.

Therefore, the coaxial conductor 155 slotted in the longitudinal direction forms a leaky waveguide conductor 154.

The leaky waveguide conductor 154 is supplied by a central control station (not shown) or by further vehicles with high-frequency signals, which spread out along the leaky waveguide conductor 154 and are received by the near-field coupler 148 of the vehicle 128. An evaluation circuit (not shown) in the vehicle 128 demodulates these high-frequency signals and converts these into data that can be used by the control unit of the vehicle 128.

Conversely, data produced in the control unit of the vehicle 128 are modulated up to a high-frequency carrier signal by a modulation circuit and are fed via the near-field coupler 148 into the leaky waveguide conductor 154, where these signals spread out to another vehicle or to the stationary control station of the transport system 100.

Besides communication with the stationary control station and with other vehicles, the mobile data handling unit 146 of the vehicle 128 at the same time serves for data communication with local stationary data handling units 159, which can be configured in particular as position indicators 160, which serve to determine the position of the vehicle 128.

Such position indicators 160 are arranged along the rail 102 and respectively comprise a position signal transmitter 162, which is arranged on the web 120 of the rail 102 at substantially the same level as the data transmission line 150.

This signal transmitter 162 transmits a position signal, which contains an identification code assigned to the position indicator 160 and is received by the near-field coupler 148 of the vehicle 128, when the vehicle 128 passes the respective position signal transmitter 162.

From the identification code contained in the signal received from the position signal transmitter 162, the control unit of the vehicle 128 determines the current position of the vehicle 128 in the rail system of the suspended monorail system 100, since the relevant position data are filed in the memory of the control unit relative to each identification code.

In principle, the position signal transmitter 162 and the near-field coupler 148 can be any desired transmitting or receiving systems, which can communicate with one another.

However, in a preferred configuration of the invention it is provided that the position signal transmitter 162 can be, for example, a bluetooth transmitter and/or a UMTS transmitter and/or a “wireless LAN” (WLAN) transmitter, and the near-field coupler 148 can be a bluetooth receiver and/or a UMTS receiver and/or a “wireless LAN” (WLAN) receiver.

The position signal transmitter 162 can be connected to any desired energy supply system, for example, a stationary power supply network, for its energy supply.

Alternatively or additionally hereto, the position signal transmitter 162 can also comprise an accumulator for storage of the required energy.

Since the position signal transmitter 162 has a width of spread in the range of about 3 cm to about 4 cm, the position determination of the vehicle 128 performed solely by means of the position signal is subject to a correspondingly large degree of inaccuracy.

In order to increase the accuracy of the position determination, each position indicator 160 also comprises, besides the position signal transmitter 162, an auxiliary marking 164, which is arranged at a predetermined distance from the position signal transmitter 162 on the rail 102 and is detectable by means of an auxiliary sensor 166 arranged on the vehicle 128.

The auxiliary marking 162 can be, for example, an optical marking, e.g. a black, white or colored slash, which is detectable by an auxiliary sensor 166 configured as an optical sensor.

Alternatively or additionally hereto, an electrically conductive element can also be used as auxiliary marking 164, which is detectable by means of an auxiliary sensor 166 configured as an inductive sensor.

The current position of the vehicle 128 in relation to the auxiliary marking 164 can be determined accurately to the millimeter by means of the auxiliary sensor 166.

By means of the position indication signal, which the near-field coupler 148 receives at the same time from the position signal transmitter 162, the control unit of the vehicle 128 can determine, which position indicator 160 the auxiliary marking 164 just detected by the auxiliary sensor 166 is associated with, and thus determine the exact position of the vehicle 128 within the rail system of the suspended monorail system 100.

The auxiliary sensor 166 and the near-field coupler 148 are preferably arranged on the vehicle 128 in the same spatial relation as the auxiliary marking 164 and the position signal transmitter 162 are arranged on the rail 102, so that the near-field coupler 148 receives the maximum signal intensity from the position signal transmitter 162 precisely at the time when the auxiliary sensor 166 detects the auxiliary marking 164.

We claim:

1. Track-guided transport system, in particular suspended monorail system, comprising
a data transmission line arranged along a track, and
at least one vehicle, which can be run along the track and comprises at least one mobile data handling unit to receive signals from the data transmission line and/or to transmit signals to the data transmission line,
characterized in that the transport system comprises at least one local stationary data handling unit, which comprises a signal transmitter, which transmits a signal, which is received by the mobile data handling unit of the vehicle, and/or a signal receiver, which receives a signal, which is transmitted from the mobile data handling unit of the vehicle.

2. Transport system according to claim 1, wherein the stationary data handling unit is configured as a position indicator, which comprises a position signal transmitter, which transmits a position signal, which is received by the mobile data handling unit of the vehicle.

3. Transport system according to claim 2, wherein the position indicator comprises an auxiliary marking and wherein the vehicle comprises an auxiliary sensor, by means of which the auxiliary marking is detectable.

4. Transport system according to claim 3, wherein the auxiliary marking comprises an optical marking and the auxiliary sensor comprises an optical sensor.

5. Transport system according to claim 3, wherein the auxiliary marking comprises an electrically conductive element and the auxiliary sensor comprises an inductive sensor.

6. Transport system according to claim 1, wherein the transport system comprises a plurality of stationary data handling units, which are spaced from one another along the track.

7. Transport system according to claim 1, wherein the signal transmitter of the stationary data handling unit is configured as a bluetooth transmitter and/or as a UMTS transmitter and/or as a “wireless LAN” (WLAN) transmitter.

8. Transport system according to claim 1, wherein the mobile data handling unit comprises a near-field coupler.

9. Transport system according to claim 1, wherein the mobile data handling unit comprises a bluetooth receiver and/or a UMTS receiver and/or a “wireless LAN” (WLAN) receiver.

10. Transport system according to claim 1, wherein the data transmission line comprises a leaky waveguide.

11. Transport system according to claim 10, wherein the leaky waveguide is an open coaxial conductor.

12. Transport system according to claim 10, wherein the leaky waveguide is configured as a slotted coaxial conductor.

13. Transport system according to claim 1, wherein the transport system comprises at least one rail section, on which the vehicle is movably guided, and wherein the data transmission line is held on the rail section.

14. Transport system according to claim 13, wherein the data transmission line is arranged between an energy transmission line and a running surface of the rail section.

15. Transport system according to claim 13, wherein the signal transmitter and/or the signal receiver of the stationary data handling unit is held on the rail section.

16. Transport system according to claim 15, wherein the signal transmitter and/or the signal receiver of the stationary data handling unit is arranged between an energy transmission line and a running surface of the rail section.
